(19) United States
(12) Patent Application Publication
(10) Pub. No.: US 2023/0301310 A1
(43) Pub. Date: Sep. 28, 2023

(54) CONVEYOR OVEN APPARATUS AND METHOD

(71) Applicant: THE MIDDLEBY CORPORATION, Elgin, IL (US)

(72) Inventors: William S. Schjerven, SR., Schaumburg, IL (US); Richard H. Van Camp, Aurora, IL (US); Theodore James Chmiola, Roscoe, IL (US)

(21) Appl. No.: 18/327,562

(22) Filed: Jun. 1, 2023

Related U.S. Application Data
(63) Continuation of application No. 16/498,158, filed on Sep. 26, 2019.
(60) Provisional application No. 62/483,197, filed on Apr. 7, 2017.

(51) Int. Cl. A21B 1/24; A21B 1/26; A21B 1/48

(52) U.S. Cl. CPC A21B 1/245; A21B 1/26; A21B 1/48

(57) ABSTRACT

Conveyor ovens for cooking food according to various embodiments include variable speed fans to deliver air from a plenum into at least two lower cooking zones below a conveyor of the oven, and at least one variable speed fan to deliver air from the plenum into one or more upper cooking zones above the conveyor, wherein a controller operates the fans delivering air into the lower cooking zones independently of each other and independently of the other fan. The fans can be controlled so that air delivered to a bottom side of the conveyor has a speed that is different in the different lower cooking zones and/or is different than air delivered to the top side of the conveyor. In some cases, the speed of the fans is predetermined and set in accordance with the type of food to be cooked.

### CROSS-REFERENCE TO RELATED APPLICATIONS

This application is a continuation of U.S. application Ser. No. 16/498,158, filed Sep. 26, 2019, which is a National Phase filing of International Application No. PCT/US2018/026067 filed on Apr. 4, 2018, which claims priority to U.S. Provisional Patent Application No. 62/483,197 filed on Apr. 7, 2017, the entire contents of which are incorporated herein by reference.

### BACKGROUND

Conveyor ovens are widely used for cooking pizzas and a wide variety of other food products. Examples of such ovens are shown, for example, in U.S. Pat. Nos. 5,277,105, 6,481,433 and 6,655,373, as well as U.S. Pat. Nos. 8,281,779, 8,087,407, and 9,585,401.

Conveyor ovens are typically large metallic housings with a heated tunnel extending through them and a conveyor running through the tunnel. In many cases, such conveyor ovens are either 70 or 55 inches long, although they may be constructed in any other suitable size. The conveyor transports food products through the heated oven tunnel at a speed which cooks food products during their transit through the tunnel. Conveyor ovens typically include a heat delivery system including one or more fans which supply heat to the tunnel through passageways leading to metal fingers opening into the oven tunnel. Such metal fingers are often located above and below the conveyor. The metal fingers act as airflow channels that deliver streams of hot air which impinge upon the surfaces of the food products passing through the tunnel on the conveyor. In modern conveyor ovens, a microprocessor-driven control panel generally enables the user to regulate heat delivery (e.g., to control the temperature within the oven, the heat output of the heat delivery system, and the like), the speed of the conveyor, and other oven functions to properly cook food product being transported through the oven.

Conveyor ovens are generally controlled with the intent to achieve repeatable and controllable heating of the oven chamber. The conveyor generally travels at a speed calculated to properly cook food products on the conveyor belt during the time period required for the conveyor to carry the food products through the entire length of the oven tunnel. In some conveyor ovens, other food products requiring less time to cook may be placed on the conveyor at a point partially through the oven chamber so that they travel only a portion of the length of the tunnel. A pizza is an example of a food product which might require the full amount of cooking time in order to be completely cooked in the oven. A sandwich is an example of a product which might require only a portion of the full cooking time. In conventional conveyor ovens, the time required to cook a pizza, for example, from an uncooked state to a fully cooked state is in excess of 4 or 5 minutes, regardless of how much heat and air flow are supplied to the conveyor supporting the pizza.

### SUMMARY

Some embodiments of the present invention a conveyor oven for cooking food, wherein the conveyor oven comprises an oven chamber; a conveyor moveable to convey food into and out of the oven chamber; a heating element assembly operable to generate heat for heating the oven chamber; a plurality of fans operable to circulate air heated by the heating element assembly through the oven chamber, wherein the plurality of fans includes at least two lower fans operable to deliver heated air to at least two separate lower cooking zones below the conveyor, and at least one upper fan operable to deliver heated air to at least one upper cooking zone above the conveyor; and a controller operable to control the conveyor, the heating element assembly, and the plurality of fans, wherein the at least two lower fans are controlled by the controller independently of each other and independently of the at least one upper fan for delivering heated air to a bottom side of the conveyor at at least two independent impingement speeds in the at least two separate lower cooking zones, and the controller further provides independent control of the at least one upper fan for delivering heated air to a top side of the conveyor at at least one independent impingement speed in the at least one upper cooking zone.

In some embodiments, a method of operating a conveyor oven to cook a food product is provided, and comprises placing the food product in an uncooked state on a conveyor to convey the food product into an oven chamber; operating a heating element assembly to heat air; delivering the heated air to the oven chamber by operating a plurality of fans; and controlling at least two lower fans of the plurality of fans independently of each other and independently of at least one upper fan of the plurality of fans with a controller to define at least two separate lower cooking zones and at least one upper cooking zone, wherein the at least two lower fans simultaneously deliver heated air to a bottom side of the conveyor at at least two independent impingement speeds in the at least two separate lower cooking zones, and wherein the at least one upper fan delivers heated air, simultaneously with the at least two lower fans, to a top side of the conveyor at at least a third independent impingement speed in the at least one upper cooking zone.

Some embodiments of the present invention provide a method of operating a conveyor oven to cook a food product, wherein the method comprises operating a heating element assembly to heat air for an oven chamber; delivering the heated air to the oven chamber by operating a plurality of fans; operating a conveyor for moving the food product through the oven chamber, the conveyor operating at a speed that defines a cooking time between an inlet of the oven chamber and an outlet of the oven chamber, wherein the cooking time is sufficient to fully cook the food product from an uncooked state; and controlling a heating output of the heating element assembly, a speed of the heated air delivered by the plurality of fans to the food product on the conveyor, and a speed of the conveyor with a controller, wherein the controller minimizes the cooking time to cook the food product by increasing the conveyor speed and reducing the speed of the heated air delivered by the plurality of fans, without increasing the heating output of the heating element assembly.

In some embodiments, a conveyor oven for cooking food is provided, wherein the conveyor oven comprises an oven chamber; a conveyor moveable to convey food into an inlet of the oven chamber and out of an outlet of the oven chamber; a heating element assembly operable to generate heat for heating the oven chamber; at least one fan operable to recirculate air heated by the heating element assembly from a heater chamber into the oven chamber and back to the heater chamber; and a controller operable to control the conveyor, the heating element assembly, and the at least one fan, wherein the controller is operable to control the at least one fan to deliver heated air to the conveyor at an impingement speed while controlling the conveyor to operate at a speed that results in a resident time of no more than 3.5 minutes of the food product in the oven chamber between the inlet and the outlet.

Some embodiments of the present invention provide a conveyor oven for cooking food, wherein the conveyor oven comprises an oven chamber; a conveyor moveable to convey food into an inlet of the oven chamber and out of an outlet of the oven chamber; a heating element assembly operable to generate heat for heating the oven chamber; at least two fans operable to recirculate air heated by the heating element assembly from a heater chamber into the oven chamber and back to the heater chamber; and a controller operable to control the conveyor, the heating element assembly, and the at least two fans, wherein the controller is operable to control the conveyor to operate at a speed that results in a resident time of no more than 3.5 minutes of the food product in the oven chamber between the inlet and the outlet, while controlling a first one of the at least two fans to deliver heated air to the conveyor at an impingement speed, and while controlling a second one of the at least two fans to deliver heated air to the conveyor at an impingement speed.

In some embodiments, a method of cooking a pizza in a conveyor oven is provided, and comprises providing the pizza in an uncooked state to an upstream end of a conveyor movable through an oven chamber of the conveyor oven; operating a heating element assembly to heat air for the oven chamber; delivering the heated air to the oven chamber by operating a plurality of fans; operating the conveyor at a speed by which the pizza is conveyed through the oven chamber in less than 4 minutes; delivering heated air from a first one of the plurality of fans to a first cooking zone, the heated air impinging upon a bottom surface of a crust of the pizza at a first speed; and delivering heated air from a second one of the plurality of fans to a second cooking zone spaced downstream from the first cooking zone along the conveyor, the heated air in the second cooking zone impinging upon a bottom surface of a crust of the pizza at a second speed that is greater than or less than the first speed of air impingement in the first cooking zone.

In some embodiments, a conveyor oven for cooking food is provided, and includes an oven chamber; a conveyor moveable to convey food into and out of the oven chamber; a heating assembly operable to heat air in a plenum for convection cooking of food moving through the oven chamber; a plurality of fans in fluid communication with and operable to circulate the air heated in the plenum through the oven chamber, wherein the plurality of fans includes at least two variable speed lower fans operable to define and deliver heated impingement air to at least two lower cooking zones below the conveyor, and at least one variable speed upper fan operable to define and deliver heated impingement air to at least one upper cooking zone above the conveyor; and a controller configured to control the conveyor, the heating assembly, and the plurality of fans, wherein the controller is configured to operate the at least two lower fans independently of each other and independently of the at least one upper fan, wherein the controller is operable to control the plurality of fans so that the speed of heated impingement air delivered to a bottom side of the conveyor in a first of the at least two lower cooking zones is different from the speed of heated impingement air delivered to the bottom side of the conveyor in a second of the at least two lower cooking zones and the speed of the heated impingement air delivered to the bottom side of the conveyor in each of the first and second lower cooking zones of the at least two lower cooking zones is different from the speed of heated impingement air delivered to a top side of the conveyor in the at least one upper cooking zone, and wherein the speed of each of the variable speed fans is predetermined and set in accordance with the type of food to be cooked.

In some embodiments, a conveyor oven for cooking food is provided, and includes an oven chamber; a conveyor moveable to convey food into and out of the oven chamber; a heating assembly operable to heat air in a plenum for convection cooking of food moving through the oven chamber; a plurality of fans in fluid communication with and operable to circulate the air heated in the plenum through the oven chamber, wherein the plurality of fans includes at least two variable speed lower fans operable to define and deliver heated impingement air to at least two lower cooking zones below the conveyor, and at least one variable speed upper fan operable to define and deliver heated impingement air to at least one upper cooking zone above the conveyor; and a controller configured to control the conveyor, the heating assembly, and the plurality of fans, wherein the controller is configured to operate the at least two lower fans independently of each other and independently of the at least one upper fan, wherein the controller is operable to control the plurality of fans so that the speed of heated impingement air delivered to a bottom side of the conveyor in a first of the at least two lower cooking zones is different from the speed of heated impingement air delivered to the bottom side of the conveyor in a second of the at least two lower cooking zones and the speed of the heated impingement air delivered to the bottom side of the conveyor in each of the first and second lower cooking zones of the at least two lower cooking zones is different from the speed of heated impingement air delivered to a top side of the conveyor in the at least one upper cooking zone, and wherein the speed of each of the variable speed fans is predetermined and set in accordance with the type of food to be cooked.

Some embodiments of the present invention provide a conveyor oven for cooking food, wherein the conveyor oven includes an oven chamber; a conveyor moveable to convey food into and out of the oven chamber; a heating assembly operable to heat air in a plenum for convection cooking of food moving through the oven chamber; a plurality of fans in fluid communication with and operable to circulate the air heated in the plenum through the oven chamber, wherein the plurality of fans includes at least two variable speed lower fans operable to define and deliver heated impingement air to at least two lower cooking zones below the conveyor, and at least one variable speed upper fan operable to define and deliver heated impingement air to at least one upper cooking zone above the conveyor; and a controller configured to control the conveyor, the heating assembly, and the plurality of fans, wherein the controller is configured to operate the at least two lower fans independently of each other and independently of the at least one upper fan, wherein the controller is operable to control the plurality of fans so that the speed of heated impingement air delivered to a bottom side of the conveyor in a first of the at least two lower cooking zones is different from the speed of heated impingement air delivered to the bottom side of the conveyor in a second of the at least two lower cooking zones and the speed of the heated impingement air delivered to the bottom side of the conveyor in each of the first and second lower cooking zones of the at least two lower cooking zones is different from the speed of heated impingement air delivered to a top side of the conveyor in the at least one upper cooking zone, and wherein the speed of each of the variable speed fans is predetermined and set in accordance with the type of food to be cooked.

In some embodiments, a conveyor oven for cooking food is provided, and includes an oven chamber; a conveyor moveable to convey food into and out of the oven chamber; a single heating assembly operable to heat air in a single plenum for convection cooking of food moving through the oven chamber; a plurality of fans in fluid communication with and operable to circulate the air heated in the single plenum through the oven chamber, wherein the plurality of fans includes a first variable speed lower fan operable to define and deliver heated impingement air to a first lower cooking zone below the conveyor, a second variable speed lower fan operable to define and deliver heated impingement air to a second lower cooking zone below the conveyor, a first variable speed upper fan operable to define and deliver heated impingement air to a first upper cooking zone above the conveyor, and a second variable speed upper fan operable to define and deliver heated impingement air to a second upper cooking zone above the conveyor; and a controller configured to control the conveyor, the single heating assembly, and the plurality of fans, wherein the controller is configured to operate (i) the first and second lower fans independently of each other, (ii) the first and second upper fans independently of each other, and (iii) each of the first and second upper fans independently of each of the first and second lower fans, wherein the controller is operable to control the plurality of fans so that the speed of heated impingement air delivered to a bottom side of the conveyor in the first lower cooking zone is different from the speed of heated impingement air delivered to a bottom side of the conveyor in the second lower cooking zone, the speed of heated impingement air delivered to an upper side of the conveyor in the first upper cooking zone is different from the speed of heated impingement air delivered to the upper side of the conveyor in the second upper cooking zone, and the speed of the heated impingement air delivered to the bottom side of the conveyor in each of the first and second lower cooking zones is different from the speed of heated impingement air delivered to the top side of the conveyor in each of the first and second upper cooking zones, and wherein the speed of each of the variable speed fans is predetermined and set in accordance with the type of food to be cooked.

Other aspects of the invention will become apparent by consideration of the detailed description and accompanying drawings.

### BRIEF DESCRIPTION OF THE DRAWINGS

The aspects and features of various exemplary embodiments will be more apparent from the description of those exemplary embodiments taken with reference to the accompanying drawings, in which:

FIG. 1 is a perspective view of a conveyor oven in accordance with an embodiment of the present invention;

FIG. 2 is a front view of the conveyor oven of FIG. 1;

FIG. 3 is a rear view of the conveyor oven of FIG. 1;

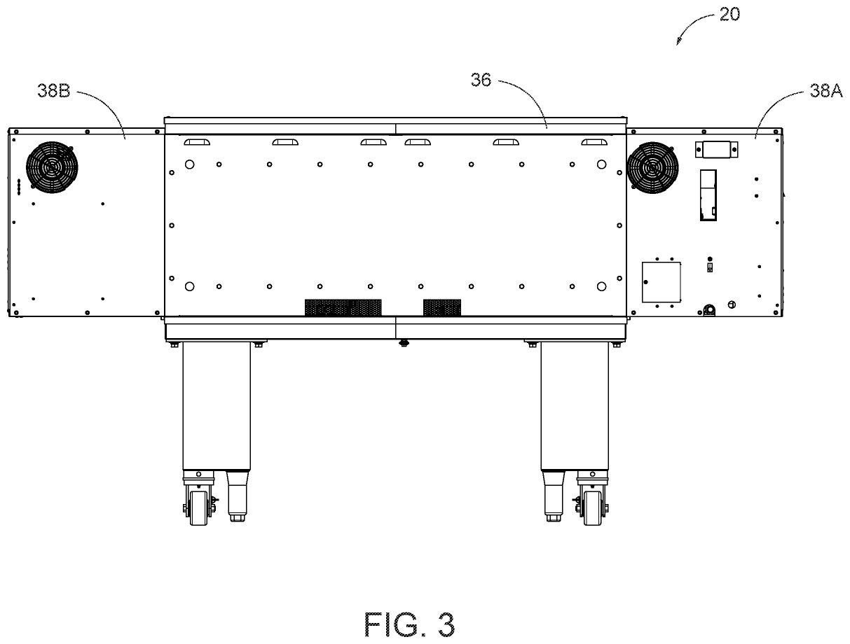

FIG. 4 is a right side view of the conveyor oven of FIG. 1;

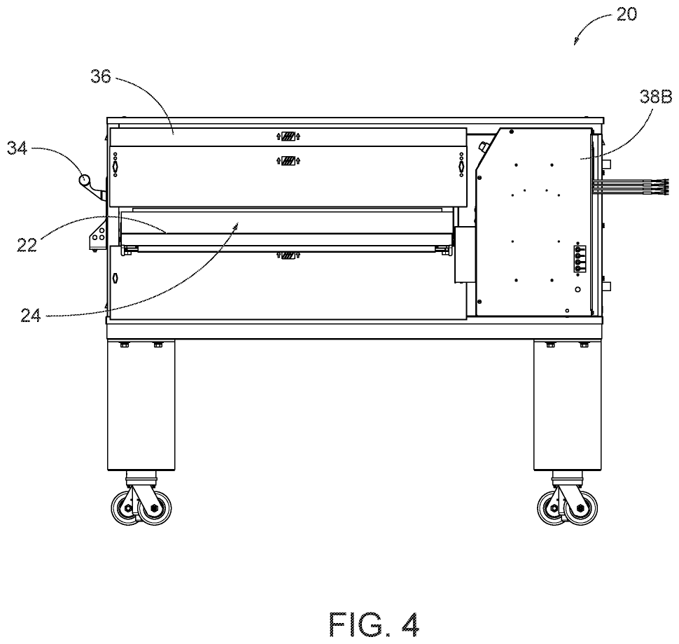

FIG. 5 is a left side view of the conveyor oven of FIG. 1;

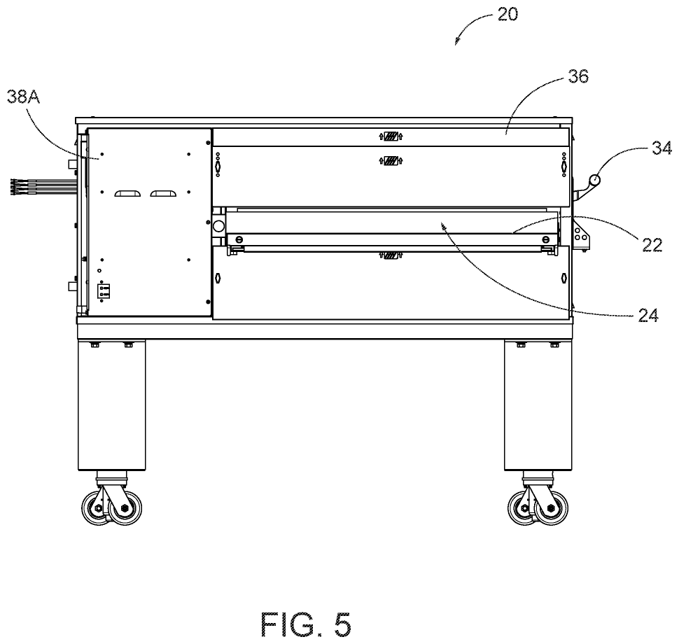

FIG. 6 is a top view of the conveyor oven of FIG. 1;

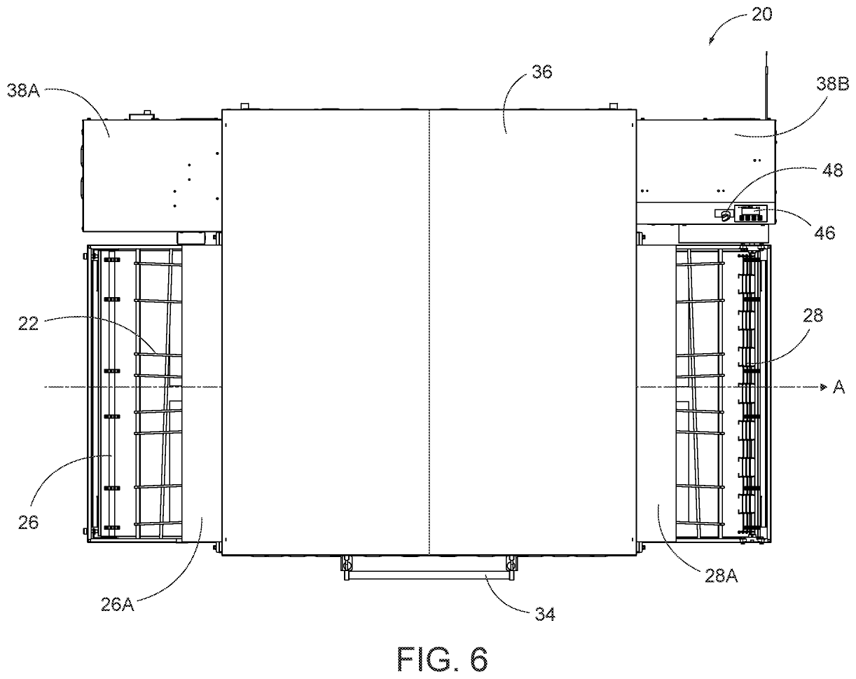

FIG. 7 is a perspective view of the conveyor oven of FIG. 1, in which portions of the oven housing are removed to illustrate the cooking chamber;

FIG. 8 is an enlarged perspective view of a portion of FIG. 7, illustrating a group of upper and lower fingers for heated air delivery;

FIG. 9 is a perspective view similar to FIG. 7, in which all of the fingers are removed to illustrate air delivery ports that supply the respective fingers;

FIG. 10 is a front view of the conveyor oven, in which the fingers are removed;

FIG. 11 is an enlarged perspective view of the cooking chamber of the conveyor oven of FIG. 1, in which a central portion of the conveyor is removed;

FIG. 12 is a perspective view of the conveyor oven of FIG. 1, in which additional housing panels are removed to illustrate a pair of upper fans;

FIG. 13 is a rear perspective view of the conveyor oven of FIG. 1, in which rear and upper housing panels are removed;

FIG. 14 is an alternate rear perspective view of the conveyor oven of FIG. 1, in which the rear and upper housing panels are removed;

FIG. 15 is a rear view of the conveyor oven of FIG. 1, in which the rear and upper housing panels are removed;

FIG. 16 is an enlarged rear perspective view of the conveyor oven of FIG. 1, in which the upper fans are removed to illustrate burner and passive tubes assemblies, and a pair of lower fans;

FIG. 17 is a plan view of the conveyor oven of FIG. 1, illustrating the lower fans and lower fingers beneath the burner and passive tube assemblies; and

FIG. 18 is a schematic illustration of an embodiment of a control system of the conveyor oven of FIG. 1.

### DETAILED DESCRIPTION

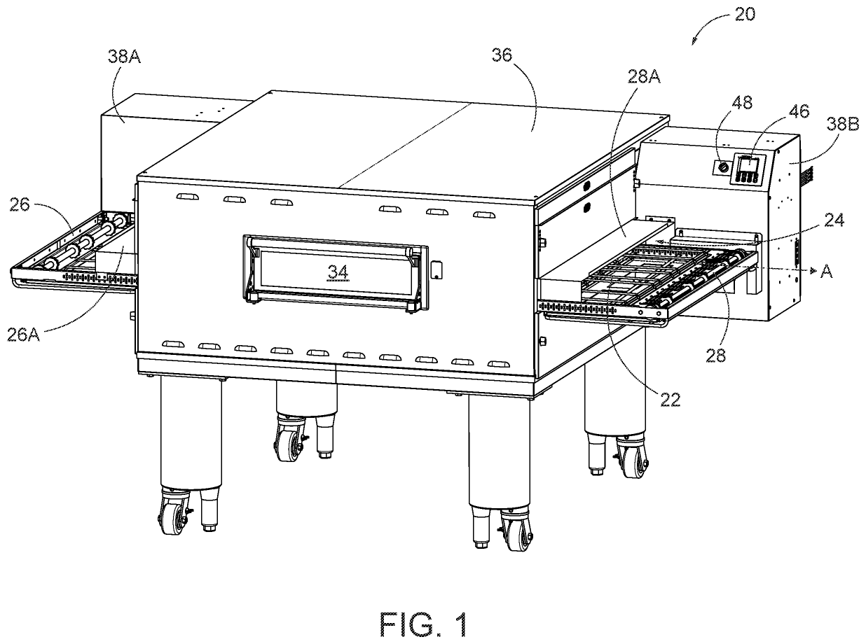

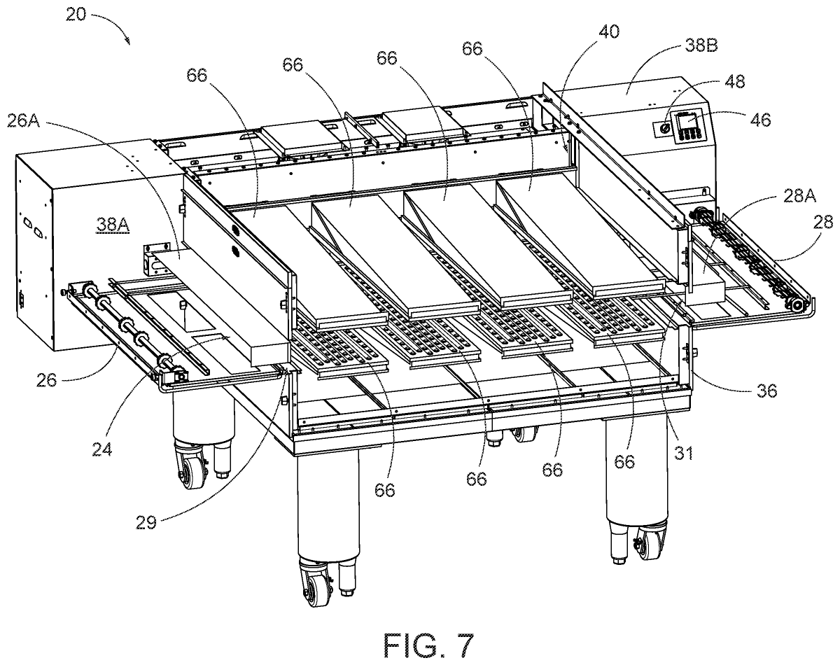

FIG. 1 illustrates a conveyor oven 20 having a conveyor 22 which runs through a heated tunnel 24 of the oven 20. The conveyor 22 has a width generally corresponding to the width of the heated tunnel 24, and is designed to travel in a first direction A from left oven end 26 toward right oven end 28 or, alternatively, in the opposite direction from right oven end 28 toward left oven end 26. Thus, the oven ends 26 and 28 may correspond to the inlet and outlet of the oven 20 in the case where the conveyor 22 moves in direction A, or as the outlet and inlet in the case where the conveyor 22 moves opposite direction A. In particular, and with reference to FIG. 7, the inlet of the oven 20 can be defined as the first point at which a portion of a food product on the conveyor 22 is fully surrounded by an oven chamber 40 on all sides (i.e., lateral sides, top, and bottom) of the conveyor 22, whereas the outlet can be defined as the last point at which a portion of a food product on the conveyor 22 is fully surrounded by the oven chamber 40 on all sides (i.e., lateral sides, top, and bottom). These inlet and outlet points are designated with reference numerals 29 and 31, respectively, in FIG. 7, and are defined by respective openings in vertical walls of the oven housing. It should be noted that some conveyor ovens can include a canopy 26A, 28A at the inlet 29 or outlet 31, respectively, of the conveyor oven tunnel 24, in which case the locations of the inlet and outlet 29, 31 described above remain unchanged despite the fact that a canopy 26A, 28A is at or immediately adjacent the inlet 29 or outlet 31, and extends away from the inlet 29 or outlet 31 by some distance.

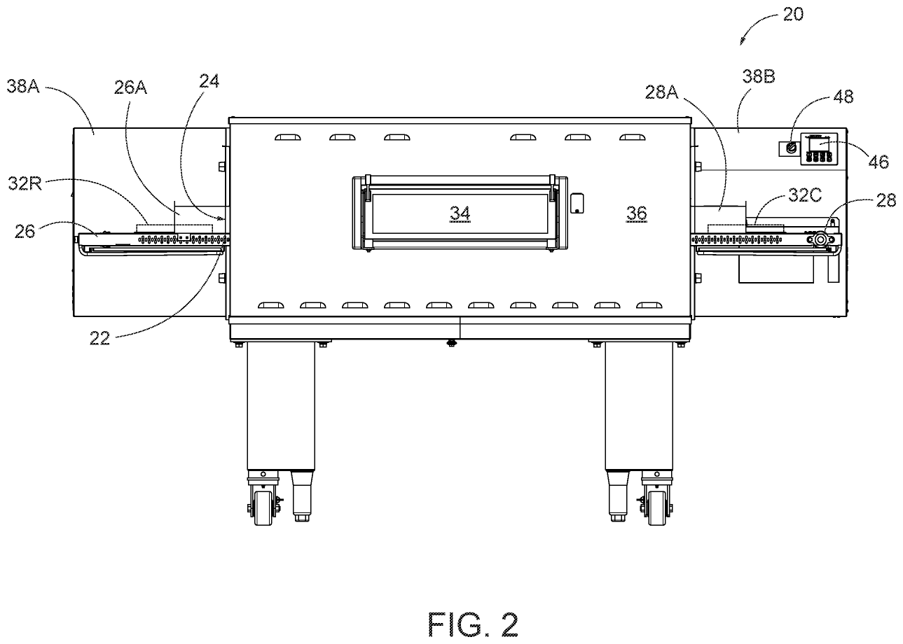

Driving of the conveyor 22 can be achieved through one or more electric motors or other motion control device(s), and can be controlled by a microprocessor-based controller 30 or other type of controller. The controller 30 may allow a user to adjust parameters of conveyor operation, such as conveyor speed and/or direction through a user interface. However, the controller 30 may also control conveyor operation according to predefined algorithms stored and executed by the controller 30 in response to basic inputs from the user, such as predefined settings according to one or more of: food product type, cooking style, cooking time, or target temperature, or in response to simply starting up the oven 20 or the conveyor 22 into an ON state. A food product, such as a raw pizza 32R, may be placed on the conveyor 22 of the ingoing left oven end 26 and removed from the conveyor 22 as fully cooked pizza 32C (see FIG. 2) at the outgoing right oven end 28. The speed at which the conveyor 22 moves can be coordinated with the temperature in the heated tunnel 24 so that the emerging pizza 32C is completely cooked. In order to minimize cooking time, it is desirable to have the pizza achieve complete cooking just at the time of arrival at the exit of the tunnel 24.

In some constructions, the oven 20 includes only a single conveyor 22, provided in one or more sections, that is operable to convey food products at a single speed through the tunnel 24 at any one given time. However, in other constructions, the oven 20 can include two or more separate conveyors. For example, a first conveyor may begin at left oven end 26 and travel at one speed to the center or other location of the oven 20, while a second conveyor beginning at such a location and ending at the right oven end 28 may travel at a different speed. Alternatively, conveyors that are split longitudinally may be used, so that one conveyor carries a product from left oven end 26 to right oven end 28 while the other conveyor carries a product in the opposite direction from right oven end 28 to left oven end 26, or so that two side-by-side conveyors carry product in parallel paths and in the same direction through the tunnel 24. This enables one product to travel on the conveyor at one speed to cook one kind of product, and the other conveyor to travel on the other conveyor at a different speed to cook another kind of food product. In addition, three or more side-by-side conveyors can carry product in parallel paths through the oven 20.

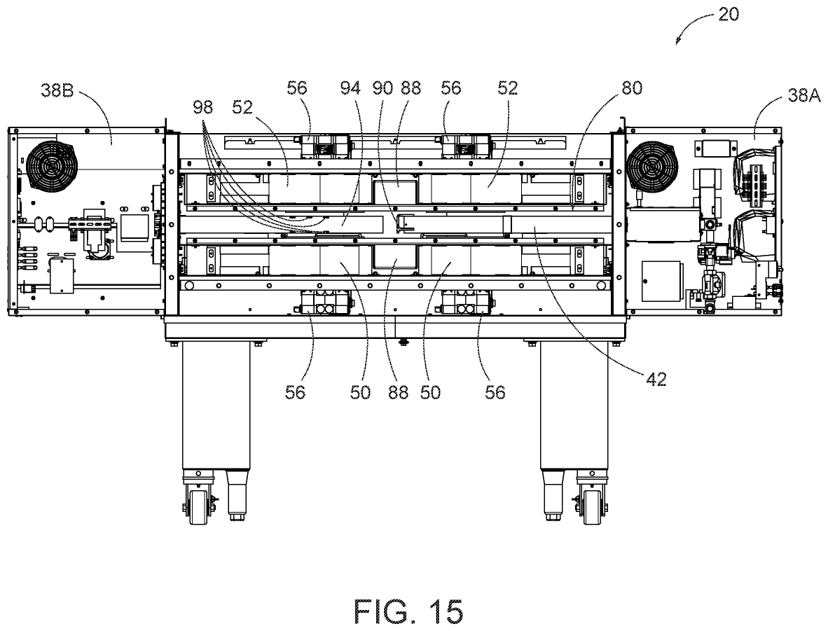

As shown in FIGS. 1 and 2, a hinged door 34 is provided on the front of the oven 20, so that a person operating the oven 20 can view and/or access the tunnel 24 or food product therein as it travels through the oven 20. The remainder of the oven 20 can have fixed panels of insulated construction forming a main oven housing 36 and one or more sub-housings or utility cabinets 38A, 38B. The main oven housing 36 defines the oven chamber 40 (FIG. 7), which is the air temperature-controlled area in which food products are cooked along the conveyor 22. The utility cabinets 38A, 38B can enclose mechanical and/or electrical utilities that allow the oven 20 to generate controlled heating and air flow to the oven chamber 40. For example, the first utility cabinet 38A can enclose mechanical, electrical, or electromechanical elements for controlling or adjusting heating output of a heating element assembly 42 (e.g., one or more gas valves for gas-fired burner(s) of FIGS. 15-17, one or more igniters of gas-fired burners, electrical components that control the current and/or voltage supplied to electrical heating elements, and the like). In some embodiments, the first utility cabinet 38A may further enclose a conduit for supplying fresh combustion air to gas-fired burner(s) of the heating element assembly 42. The second utility cabinet 38B can enclose the controller 30. The controller 30 may include a central processing unit (“CPU”) 44, one or more displays 46 (e.g., a color liquid crystal display “LCD”), and/or a control interface 48. Power electronics for controlling air-circulating fans 50, 52 (e.g., power inverters operable to drive respective fan motors 56 at variable speeds) can be positioned in one or both of the utility cabinets 38A, 38B.

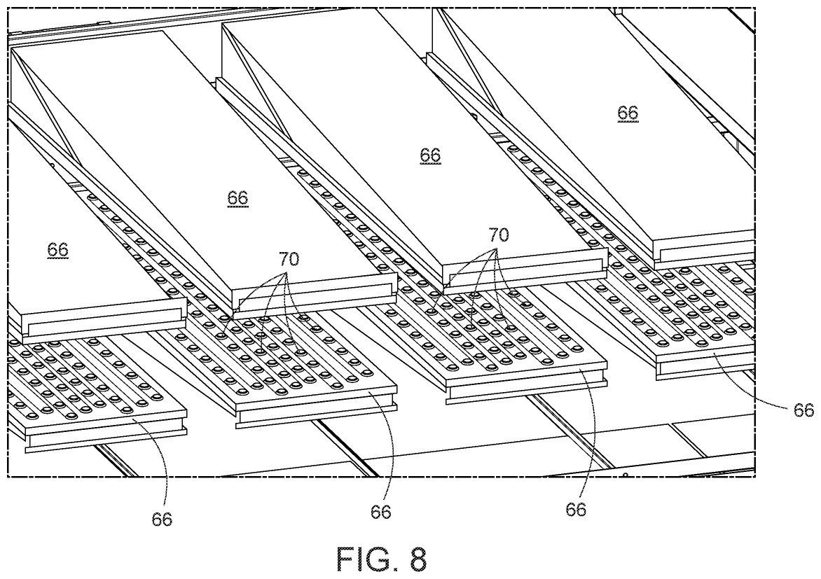

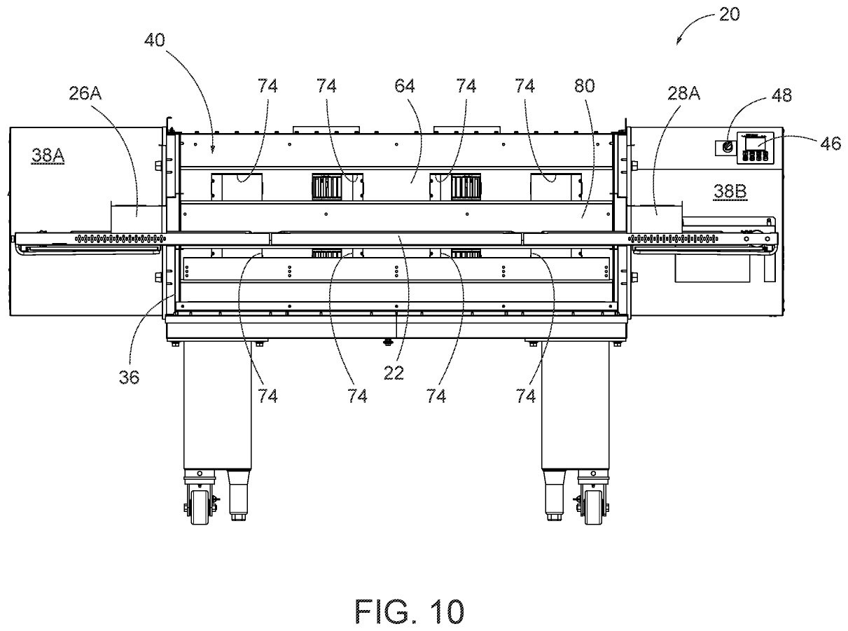

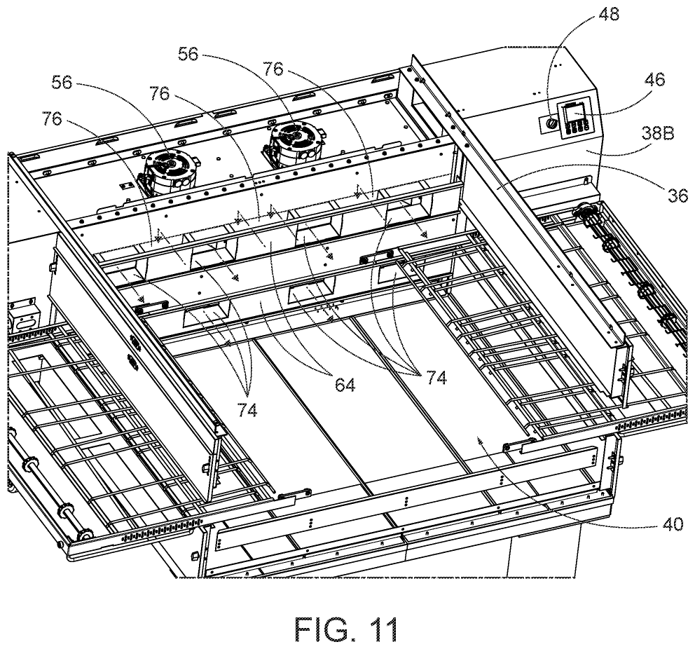

Turning now to FIGS. 7-12, the illustrated oven 20 includes a multi-zone air circulation system for providing forced air impingement of heated air to food products on the conveyor 22 inside the oven chamber 40. As mentioned above, the air circulation system can include a plurality of fans 50, 52, each operable when energized (e.g., by respective electric motors 56) to output a pressurized air flow from one or more outlets. As will be discussed further below, the fans 50, 52 can be provided as lower fans 50 operable to provide heated air flow under the conveyor 22, and upper fans 52 operable to provide heated air flow above the conveyor 22. Although the upper fans 52 are positioned above the lower fans 50 for convenience, the fans 50, 52 may be provided in any number of alternate positions and orientations with respect to one another and in the oven 20, either behind the oven chamber 40 as shown or elsewhere. In the illustrated embodiment, each fan 50, 52 includes two outlets 60 for providing two parallel outlet air streams. The two outlets 60 of each fan 50, 52 supply the two air streams into two delivery ducts 66, or “fingers” in the illustrated embodiment. Thus, the illustrated oven 20 includes a total of four fans 50, 52 providing a total of eight outlets 60 to a total of eight fingers 66. However, in other constructions, the oven 20 can include other numbers of fans, outlets, and/or fingers to deliver heated air to the food product on the conveyor 22. After delivery of heated air to the oven chamber 20, air is drawn into upper and lower intake manifolds 64, is heated again, and then drawn back into the fans 50, 52 as will be described in greater detail below.

The fingers 66 coupled to the lower fans 50 are operable to deliver heated air flows driven by the lower fans 50 to the underside of the conveyor 22, and each finger 66 occupies a distinct location along a direction of travel of the conveyor 22. For example, in the illustrated embodiment each finger 66 extends lengthwise in a direction transverse to the conveyor 22. A top wall of each of the lower fingers 66 is provided with a plurality of apertures 70 or “nozzles”. The apertures 70 are in fluid communication with an interior chamber of the respective finger 66, and are arranged to take pressurized air delivered to the inside of the finger 66 by the respective lower fan 50 and deliver it in an upward direction. In some embodiments, some or all of the apertures 70 can direct exiting airflow in a vertical path toward the underside of the conveyor 22. The top surface of each lower finger 66 can be covered in an array of apertures 70 extending across most or all of a width of the conveyor 22 so that air from the fingers 66 will impinge upon the food product on the conveyor 22 regardless of where along the width the food product is placed. The array of apertures 70 can be provided in a variety of different patterns, only one of which is disclosed in the accompanying figures as a non-limiting example. Each of the apertures 70 can induce a flow velocity increase and a pressure decrease as the air passes therethrough, so that the heated air from the fingers 66 impinges upon food product on the conveyor 22 at relatively high speed.

The fingers 66 extending above the conveyor 22 are coupled to the upper fans 52 to deliver heated air to the top side of the conveyor 22, and a top side of any food product thereon. These fingers 66 can be provided with all the specific features of the lower fingers 66 discussed directly above. With respect to the illustrated embodiment, the only exception is that the apertures 70 of the upper fingers 66 are provided in a bottom wall of each finger 66, and are arranged to direct pressurized air in a downward direction, e.g., in vertical paths toward the top side of the conveyor 22. In other embodiments, the upper and lower fingers 66 can vary in construction (e.g., width, length, internal volume, number of apertures, sizes of aperture, or arrangement of apertures). As discussed in further detail below, the controller 30 can provide different air impingement speeds in different heating zones or cooking zones by controlling the fans 50, 52 that drive air from the respective pairs of fingers 66 coupled to each fan 50, 52 (e.g., directly controllable by a fan control as part of the control interface 48 or according to a fan control algorithm executed in response to initiating a cooking process). It is also noted here that each fan 50, 52 can be coupled to one finger 66 or to more than two fingers 66 in other embodiments.

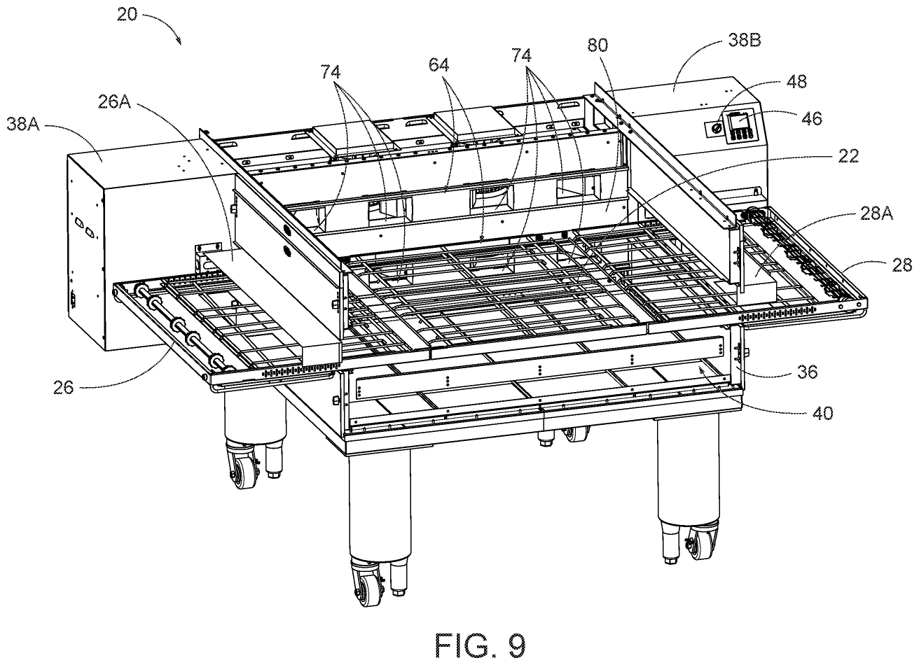

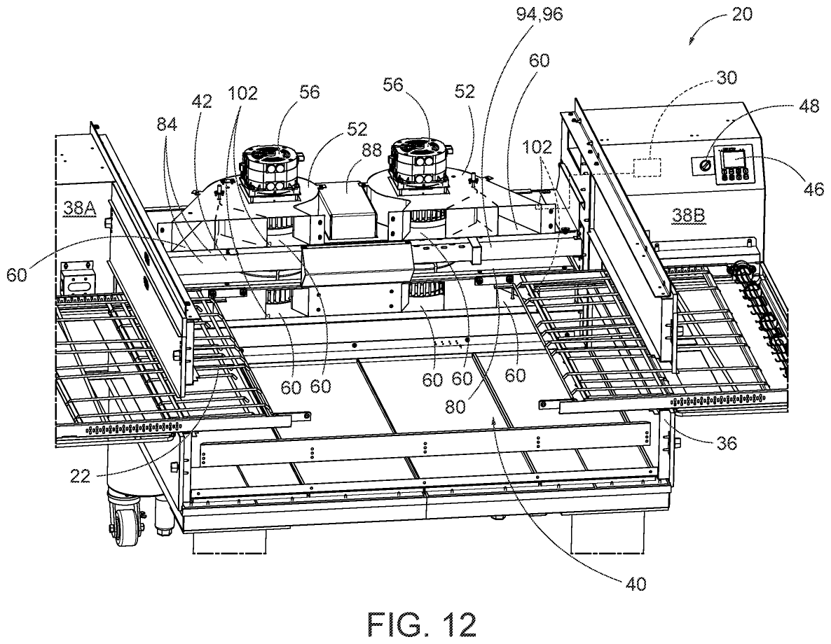

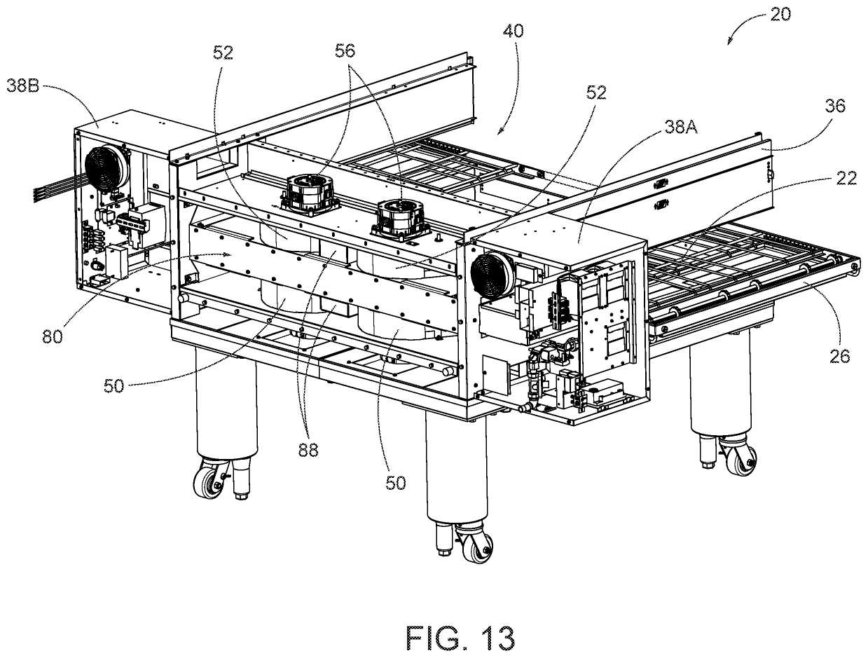

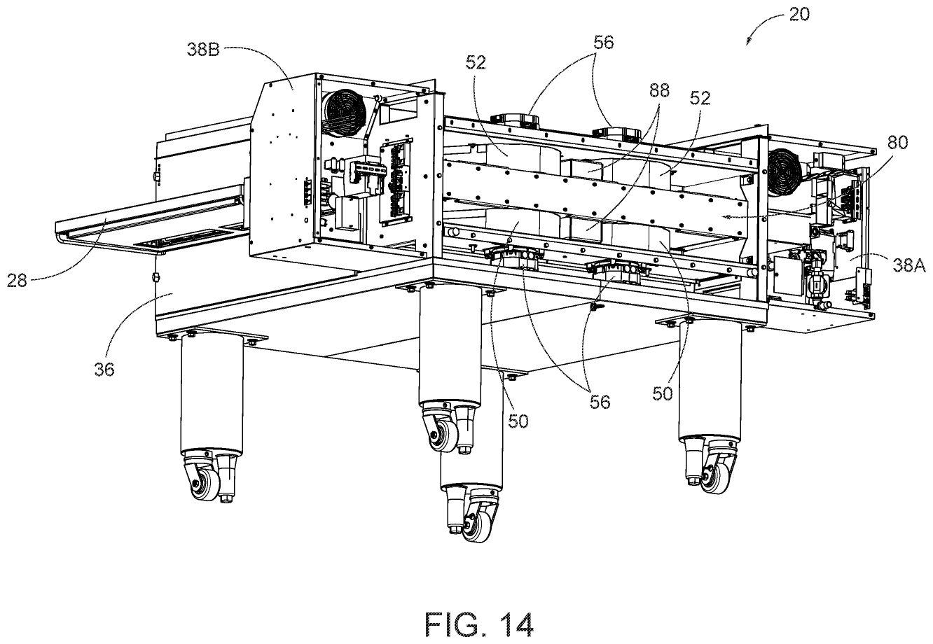

The manifolds 64 of the illustrated embodiment are described in further detail with reference to FIGS. 9-12. Each manifold 64 of the illustrated embodiment includes a baffle plate defining a plurality of delivery ports 74 and at least one return port 76. The delivery ports 74 correspond to the outlets 60 of the fans 50, 52. For example, the delivery ports 74 of the lower manifold 64 can be aligned with and/or coupled to the outlets 60 of the lower fans 50, and the delivery ports 74 of the upper manifold 64 can be aligned with and/or coupled to the outlets 60 of the upper fans 52. In the illustrated embodiment, a plurality of return ports 76 are interposed between the delivery ports 74, and the return ports 76 are oriented with a 90-degree offset with respect to the delivery ports 74. For example, the delivery ports 74 can extend to direct air horizontally into the oven chamber 40, while the return ports 76 defined by the upper manifold 64 can extend to direct air from the oven chamber 40 vertically downward as it is collected for recirculation. Though not shown, the return ports 76 defined by the lower manifold 64 can extend to direct air from the oven chamber 40 vertically upward as it is collected for recirculation, as a mirror image of the upper manifold 64. The lower fans 50 and the lower manifold 64 can define a lower air handling level of the conveyor oven 20, and the upper fans 52 along with the upper manifold 64 can define an upper air handling level of the conveyor oven. Vertically interposed between the upper and lower air handling levels is a heater level generally provided as a heater chamber 80 that encloses the heating element(s) of the heating element assembly 42 of the oven 20, as best shown in FIGS. 12-17.

The heater compartment 80 in the illustrated embodiment extends along the back of the oven chamber 40, and may span an entire length of the oven chamber 40 (measured along the conveyor travel direction). In some embodiments, such as in the illustrated embodiment, the heater compartment 80 occupies a space that is vertically sandwiched between the lower fans 50 and the upper fans 52 so that all the fans 50, 52 draw heat from a common heating chamber defined by the heater compartment 80. In the illustrated construction, the heater compartment 80 includes a single heating element assembly 42 that is positioned on one half (e.g., the upstream half with respect to conveyor travel) of the heater compartment 80 as shown in FIGS. 15-17. The heating element assembly 42 can be provided as one or more gas-fired burners (e.g., four burners, in the illustrated embodiment), commonly referred to as “in-shot burners”, and the gas-fired burners can include individual parallel tubes 84 for conveying flame toward a central portion of the heater compartment 80. Two flame traps 88 (e.g., flame receptacles) can extend downward from the heater compartment 80 to a space between the lower fans 50 and upward from the heater compartment 80 to a space between the upper fans 52 at a lengthwise-central portion of the heater compartment 80 adjacent the distal ends of the parallel tubes 84 such that the distal ends of the parallel tubes 84 are positioned directly between the upper and lower flame traps 88. A flame arrestor or “target” 90 is positioned in front of the distal end of each of the parallel tubes 84 to limit the direct extension of flame therefrom.

As best shown in FIGS. 15-17, the heating element assembly 42, particularly the parallel tubes 84 of the gas-fired burners, extend directly over one of the lower fans 50 and directly under one of the upper fans 52. The heating element assembly 42 can extend across (e.g., directly over or directly under in plan view) respective inlets of the lower and upper fans 50, 52. As shown, the fans 50, 52 are centrifugal, or “squirrel cage” fans, and the inlets 92 are positioned centrally to each fan 50, 42. In the illustrated embodiment, assuming operation of the conveyor 22 in axial direction A shown in FIG. 1, the heating element assembly 42 extends directly between the lower and upper fans 50, 52 feeding the fingers 66 on the upstream half of the oven chamber 40. In some embodiments, such as in the illustrated embodiment, the heating element assembly 42 is the only such assembly of the oven 20, and the heat generated by the heating element assembly 42 is disseminated to all the fingers 66 in the oven chamber 40 by all the lower and upper fans 50, 52.

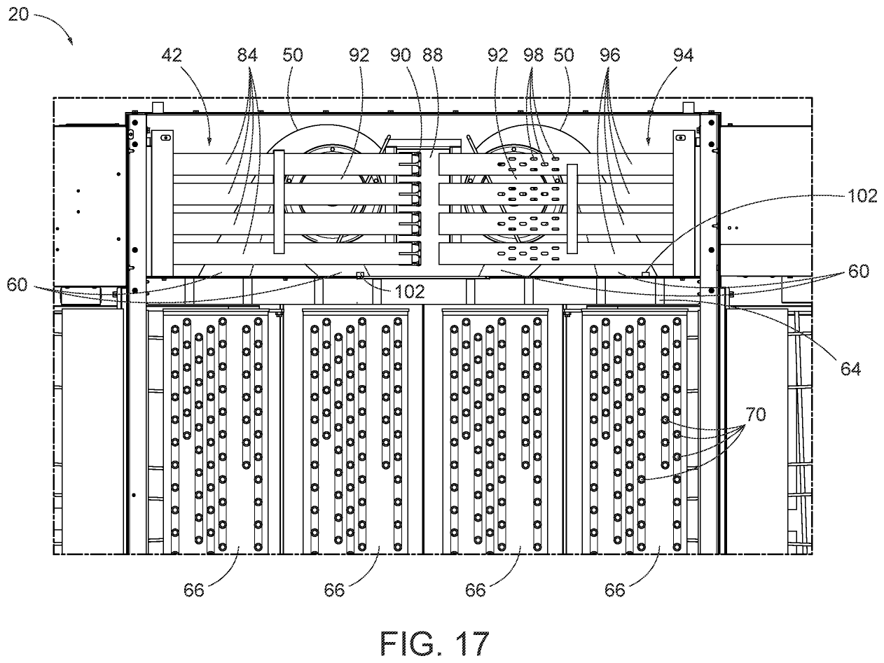

Directly across from the parallel tubes 84 of the heating element assembly 42 is a passive heat distributor assembly 94, including a plurality of parallel tubes 96, each one in alignment with one of the parallel tubes 84 of the heating element assembly 42 as shown in FIG. 17. Although the tubes 96 of the passive heat distributor assembly 94 are not part of a gas-fired burner or other active heating element, the tubes 96 occupy space in the heater compartment 80 similar or identical to the tubes 84 of the heating element assembly 42 so that air flow distribution in the side of the heater compartment 80 without the heating element assembly 42 remains very similar to that in the side where the heating element assembly 42 is positioned. In other words, the tubes 96 simulate the tubes 84 of the heating element assembly 42, and are situated in the space between one lower fan 50 and one upper fan 52, just as with the tubes 84 of the heating element assembly 42 between the other lower fan 50 and the other upper fan 52.

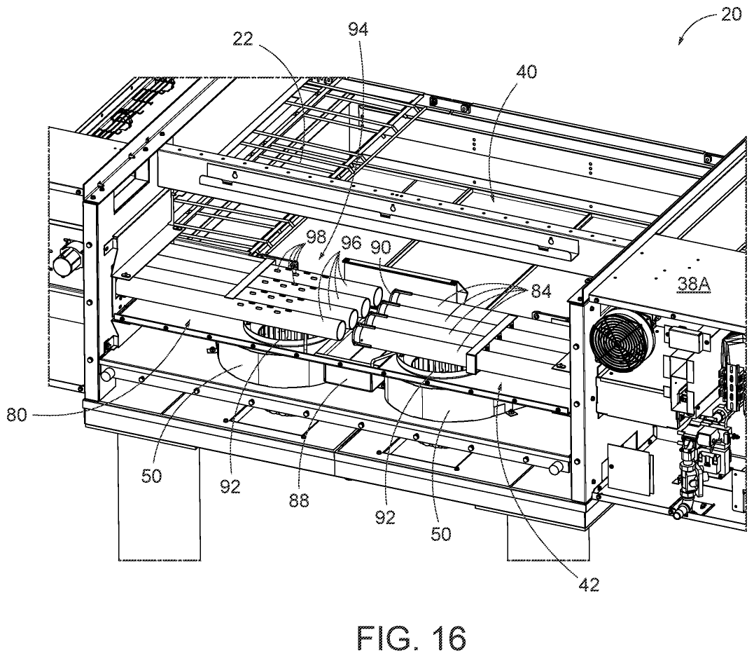

As best shown in FIGS. 16 and 17, the tubes 96 of the passive heat distributor assembly 94 can be further provided with an array of apertures 98, at least some of which directly overlap with the inlets 92 of one lower fan 50 and one upper fan 52 in plan view (i.e., see FIG. 17, in which the upper fans have been removed, but are positioned directly over the lower fans 50). In some constructions, a majority of the apertures 98 or even all of the apertures 98 are positioned to directly overlap the fan inlets 92. The tubes 96 of the passive heat distributor assembly 94 can mimic the tubes 84 of the heating element assembly 42 in a way that creates similar pressure and temperature profiles on both sides of the heater compartment 80. Temperature sensors 102 (FIGS. 12, 17, and 18) can be positioned at the outlets 60 of the fans 50, 52, with each temperature sensor 102 operable to sense and report a sensed temperature to the controller 30. Temperature sensors may additionally or alternately be positioned in the manifold 64, in the heater compartment 80, or in the oven chamber 40 as a means for detecting temperatures corresponding to the different fans 50, 52 and different cooking zones of the oven 20. Temperature inputs to the controller 30 can provide feedback as a means for controlling one or more of: heat output from the heating element assembly 42, speed of the conveyor 22, and speed(s) of the fan(s) 50, 52. Each temperature sensor 102 can be constructed as a thermocouple or other type of temperature sensing element.

Although the passive heat distributor assembly 94 can ensure adequate heating for air supplied through the inlets 92 of the fans 50, 52 remote from the heating element assembly 42, heating or cooking effect is not necessarily uniform within the oven chamber 40. While uniformity may be desirable in some circumstances, and may be achievable by the oven 20 as described herein, the controller 30 is operable to provide more sophisticated cooking schemes to optimize the potential provided by the individual fans 50, 52 and cooking zones. In particular, the controller 30 may provide zone-specific heated air supply to achieve reduced cooking times that have yet been unattainable with conventional conveyor ovens. For example, the controller 30 may operate the conveyor 22 at a speed that passes a food product through the oven chamber 40 in less than four minutes, and in some cases no more than 3.5 minutes utilizing the fan and conveyor speed control described herein, wherein the food product can be fully cooked from an uncooked state between the inlet and the outlet of the oven 20.

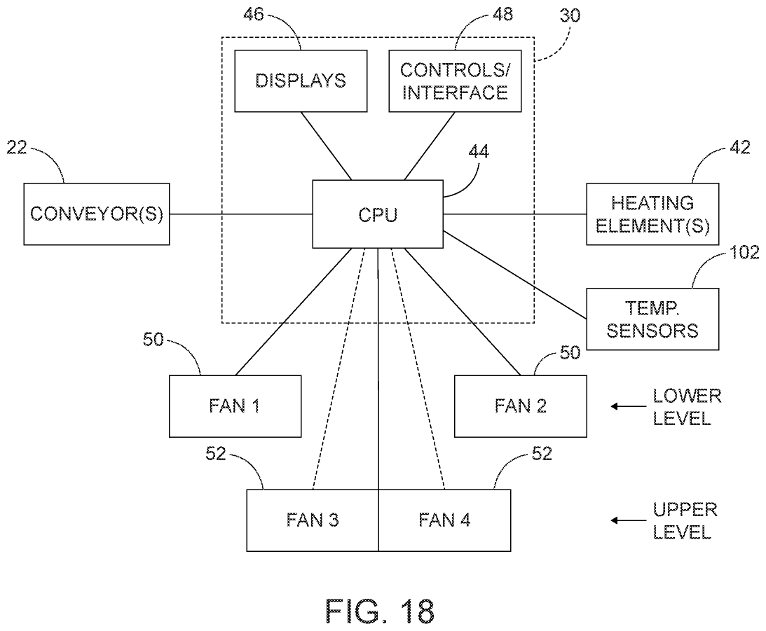

The oven 20 can receive electrical power through a cord plugged into a wall outlet or socket, or other electrical power supply. Such power is provided as alternating current (AC), for example at 110V or 220V. However, the motors 56 that drive the fans 50, 52 can operate on direct current (DC) or alternating current (AC), depending upon the type of motor selected. The motors 56 in the illustrated embodiment are variable speed motors in some embodiments. For each independently-controlled motor 56, in some embodiments an inverter is provided to receive the AC input voltage and output an AC or DC voltage to power the motor 56. Each inverter can be a variable speed inverter operable to supply power at a frequency that is varied by the controller 30 to vary the speed and thus the volumetric air flow rate output by the respective fan 50, 52. In some constructions, each individual fan 50, 52 (e.g., a total of four as shown) is independently controlled (e.g., by four respective inverters) by the controller 30. This is illustrated schematically in FIG. 18 by two solid lines extending from the CPU 44 to “FAN 1” and “FAN 2” (i.e., the lower fans 50) and the two dashed lines from the CPU 44 to “FAN 3” and “FAN 4” (i.e., the upper fans 52). In other embodiments, the two upper fans 52 are provided with unified control to be driven by the controller 30 through a single inverter, as illustrated by the single solid line from the CPU 44 to the two upper fans 52 (“FAN 3” and “FAN 4”) in FIG. 18, while independent control of the lower fans 50 (“FAN 1” and “FAN 2”) is provided by two separate additional inverters. The inverters are not separately illustrated in FIG. 18 for simplicity. In some embodiments, the number of independently-controlled fans 50, 52 may define the number of independent cooking zones within the oven chamber 40, as the fingers 66 coupled to each independently-controlled fan 50, 52 are in turn independently-controlled to deliver air to the conveyor 22 and food product thereon at various air impingement speeds.

In some embodiments, heated air from the fingers 66 can be controlled by the controller 30 so that an air impingement speed in a first lower cooking zone can be different from the air impingement speed in a second lower cooking zone, and further, different from at least one upper cooking zone (e.g., two upper cooking zones, if so equipped). Also, in some embodiments, heated air from the fingers 66 can be controlled by the controller 30 so that an air impingement speed in a first lower cooking zone can be different from the air impingement speed in a second lower cooking zone, and further, an air impingement speed in a first upper cooking zone can be different from the air impingement speed in a second upper cooking zone. By utilizing respective inverters for each fan 50, 52 supplying heated air to these zones (e.g., upstream top, upstream bottom, downstream top, and downstream bottom), much greater control over rapid cooking operations is possible.

Of course, in some cooking operations, even with the capability of independent control, one or more of the independent cooking zones may be controlled to have equivalent air impingement speeds, or at least overlapping air impingement speed ranges, such as by operating two fans 50, 52 at the same speed despite the fact that both fans 50, 52 are independently controllable and operable (e.g., by respective inverters, as described above).

In some embodiments, the speed of air impinging food product on the conveyor 22 can be controlled so that the food product experiences different air impingement speeds at different locations along the path of the conveyor 22. Such varying air impingement speeds at different conveyor locations can be achieved by changing the speed of one or more of the fans 50, 52 while food product is on the conveyor 22, or by maintaining the fans 50, 52 at constant speeds that are different from one another (in which case the food product is still exposed to different air impingement speeds based upon the location of the food product along the path of the conveyor 22). In either case, individual fan speed control can be used to establish different cooking zones in the oven 20, such as upstream and downstream zones in the illustrated embodiment that are each split into zones above and below the conveyor 22, thereby resulting in four separately controlled cooking zones in the illustrated oven.

For example, a food product may enter the oven chamber 40 and experience a first air impingement speed V₁ from below (from the upstream lower fan 50), and may subsequently experience a second air impingement speed V₂ from below (from the downstream lower fan 50) that is more or less (e.g., at least 10, 20, or 30 percent) than the first impingement speed V₁. The air from the upstream and downstream lower fans 50 can be at the same air temperature. Without altering the output of the heating element assembly 42, the different air impingement speeds from the lower fans 50 can have a significant desirable effect on the oven's ability to fully cook the food product by the time the food product reaches the outlet, where conveyor speeds are maximized to minimize cooking time. Where independent control of the upper fans 52 is also provided, the same scenario takes effect for the upper side of the food product. For example, the upstream upper fingers 66 can deliver a third air impingement speed V₃ (from the upstream upper fan 52), and the downstream upper fingers 66 can deliver a fourth air impingement speed V₄ (from the downstream upper fan 52) that is more or less (e.g., by at least 10, 20, or 30 percent) than the third impingement speed V₃. Without altering the output of the heating element assembly 42, this can have a significant desirable effect on the oven's ability to fully cook the food product by the time the food product reaches the outlet, where conveyor speeds are maximized to minimize cooking time. In the case of cooking pizza, by way of example, the independent fan control just described can reduce cook time of pizza significantly while tailoring the localized cooking environment experienced by the crust to be different than the cooking environment experienced by the toppings. When the pizza is placed directly upon the conveyor 22 (which is air permeable, in some embodiments), the ideal speed of air impinging the pizza from the lower fingers 66 has a significant impact upon the cooking effect of the crust, whereas a different ideal speed of air impinging the pizza from the upper fingers 66 has a significant impact upon the cooking effect of the toppings, which cook differently than the crust.

While fan speed can be the direct variable that is used to achieve independent control of the air impingement speeds in the various oven tunnel cooking zones described herein, other alternatives may be provided in addition or in lieu thereof to establish desired air impingement speeds on the food product. For example, individual valves, throttles, or baffles can be provided between one or more of the fans 50, 52 and the apertures 70 of the fingers 66 (e.g., at the fan outlets 60, in the manifold 64, or inside the finger(s) 66). In some embodiments, the fingers 66 themselves may have unique, independent constructions corresponding to the different cooking zones to vary the air impingement speeds in different zones without requiring independent control of fan speeds. This may be appropriate in limited cases where the oven 20 is specialized and optimized for one type of cooking operation.

In some embodiments, control of the independent air impingement speeds (i.e., in the different cooking zones of the oven 20 as described herein) can be carried out on the basis of a predetermined program or algorithm without direct feedback reporting actual air impingement speeds. In other embodiments, air speed sensors are provided to directly measure air impingement speeds and report the measured values to the controller 30. Also, in some embodiments, air impingement speed varies predictably in a fixed relationship with air pressure, and air pressure can be measured at the fan outlet(s) 60, in the manifold 64, or within the finger(s) 66). In this way, the controller 30 may exercise air impingement speed control by directly controlling pressure, with measured feedback. In such embodiments, the oven 20 can include a plurality of pressure transducers operable to measure air pressure and report a signal indicative of such measured air pressure to the controller 30 for thereafter independently controlling fan speed in any of the zones.

Regardless of how many or which parameters are measured in order to control cooking operation of the conveyor oven 20, cooking in significantly reduced cycle times can be achieved by operating outside of conventional methodology. For example, cooking time can be significantly reduced in some cases by modifying a known set of parameters that achieve complete cooking of a food product. Optimizing for reduced cooking time can include reducing air impingement speed in at least one, multiple, or all cooking zones compared to the conventional cooking cycle (along with, necessarily, increasing conveyor speed or shortening the length of the conveyor 22 between inlet and outlet compared to a conventional conveyor oven). The heating output from the heating element assembly 42 in such cases need not be increased to reduce cooking time. Rather, the food product is cooked for optimal efficiency by way of optimizing air impingement speeds in the various cooking zones, particularly exposing the food product to at least two different air impingement speeds from below the conveyor 22 via the independently controllable lower fans 50, along with another, or optionally multiple, different air impingement speeds from above the conveyor 22 via the upper fans 52. In these cases, and as described above, the independent control of each fan 50, 52 is enabled by the use of respective inverters supplying electric power to the motors of the lower fans 50, and at least one inverter (or optionally respective inverters) supplying electric power to the motors of the upper fans 52.

Air impingement speed as used herein can refer to the velocity of air exiting the apertures 70 of the fingers 66 (or similar structure used to provide air jets directed at food products on the conveyor 22) and/or the velocity of the air as it impinges upon the food product, if different from the velocity leaving the apertures 70. Each finger 66 can be designed to provide a uniform air velocity across all of its apertures 70. The fingers 66 supplied by a single fan 50, 52 can provide the same or different air impingement speed(s) depending upon their construction, or independent flow throttling. In some embodiments, where air velocity differs between two or more fingers 66 of a single cooking zone, the air impingement speed of the cooking zone can be taken as the average of the velocities among the fingers 66 in that cooking zone. Also, in some embodiments, where air velocity exiting the apertures 70 varies among a number of different velocities across a single finger 66, the air impingement speed can be taken as the average of the velocities throughout all the apertures 70 of the finger 66.

The foregoing detailed description of the certain exemplary embodiments has been provided for the purpose of explaining the principles of the application and examples of practical implementation, thereby enabling others skilled in the art to understand the disclosure for various embodiments and with various modifications as are suited to the particular use contemplated. This description is not necessarily intended to be exhaustive or to limit the application to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

What is claimed is:

1. A method of operating a conveyor oven for cooking food within an oven chamber, the method comprising:
operating a conveyor of the conveyor oven to convey food through an inlet of the oven chamber, then through a first cooking zone of the oven chamber, then through a second cooking zone of the oven chamber, and then through an outlet of the oven chamber;
heating air within a heater compartment of the conveyor oven;
operating a first fan to convey heated air from the heater compartment into the first cooking zone;
operating a second fan to convey heated air from the heater compartment into the second cooking zone;
sensing a temperature of the first cooking zone and generating a first signal based on the sensed temperature of the first cooking zone;
sensing a temperature of the second cooking zone and generating a second signal based on the sensed temperature of the second cooking zone;
controlling a speed of the first fan based on the first signal, including adjusting the speed of the first fan; and
controlling a speed of the second fan based on the second signal independent of the speed of the first fan, including adjusting the speed of the second fan.

2. The method of claim 1, wherein sensing a temperature of the first cooking zone includes sensing a temperature at an outlet of the first fan, and wherein sensing a temperature of the second cooking zone includes sensing a temperature at an outlet of the second fan.

3. The method of claim 1, wherein the first fan or the second fan conveys heated air to an upper side of the conveyor and wherein the other fan conveys heated air to an under side of the conveyor.

4. The method of claim 1, wherein each of the first cooking zone and the second cooking zone are located above the conveyor such that operating the first fan and the second fan conveys heated air from the heater compartment to the oven chamber above the conveyor.

5. The method of claim 4, further comprising, operating a third fan to convey heated air into the oven chamber below the conveyor.

6. The method of claim 1, wherein controlling the speed of the first fan based on the first signal includes controlling the speed of the first fan such that the speed of the first fan differs from the speed of the second fan.

7. The method of claim 6, wherein controlling the speed of the second fan based on the second signal includes controlling the speed of the second fan such that the speed of the second fan differs from the speed of the first fan.

8. The method of claim 1, further comprising, operating a third fan to convey heated air into the oven chamber below the conveyor.

9. The method of claim 8, further comprising controlling a speed of the third fan independent of the speed of the first fan and independent of the speed of the second fan.

10. The method of claim 9, further comprising sensing a temperature below the conveyor and generating a third signal based on the sensed temperature below the conveyor, and controlling the speed of the third fan based on the third signal.

11. The method of claim 1, wherein the air is heated within the heater compartment via a heating assembly, and wherein the speed of the first fan is controlled without altering the output of the heating assembly.

12. The method of claim 11, wherein the speed of the second fan is controlled without altering the output of the heating assembly.

13. A method of operating a conveyor oven for cooking food within an oven chamber, the method comprising:
operating a conveyor of the conveyor oven to convey food through an inlet of the oven chamber, then through a first cooking zone of the oven chamber, then through a second cooking zone of the oven chamber, and then through an outlet of the oven chamber;
heating air via a heating assembly within a heater compartment of the conveyor oven;
operating a first fan to convey heated air from the heater compartment into the first cooking zone;
operating a second fan to convey heated air from the heater compartment into the second cooking zone;
sensing a temperature of the first cooking zone and generating a first signal based on the sensed temperature of the first cooking zone;
sensing a temperature of the second cooking zone and generating a second signal based on the sensed temperature of the second cooking zone;
controlling a speed of the first fan based on the first signal; and
controlling a speed of the second fan based on the second signal,
wherein the speed of the first fan and/or the second fan is controlled without altering an output of the heating assembly.

14. The method of claim 13, wherein the speed of the first fan and the second fan is controlled without altering the output of the heating assembly.

15. The method of claim 13, wherein sensing a temperature of the first cooking zone includes sensing a temperature at an outlet of the first fan, and wherein sensing a temperature of the second cooking zone includes sensing a temperature at an outlet of the second fan.

16. The method of claim 13, wherein the first fan or the second fan conveys heated air to an upper side of the conveyor and wherein the other fan conveys heated air to an under side of the conveyor.

17. The method of claim 13, further comprising reducing the speed of the first fan and/or the second fan such that a cooking time is reduced.

18. The method of claim 13, further comprising:
operating a third fan to convey heated air into the oven chamber below the conveyor; and
controlling a speed of the third fan independent of the speed of the first fan and independent of the speed of the second fan.

19. The method of claim 13, further comprising sensing a temperature below the conveyor and generating a third signal based on the sensed temperature below the conveyor, and controlling the speed of the third fan based on the third signal.

20. A method of operating a conveyor oven for cooking food within an oven chamber, the method comprising:
operating a conveyor of the conveyor oven to convey food through an inlet of the oven chamber, then through a first cooking zone of the oven chamber, then through a second cooking zone of the oven chamber, and then through an outlet of the oven chamber;
heating air within a heater compartment of the conveyor oven;
operating a first fan to draw heated air from the heater compartment and discharge the heated air into the first cooking zone;
operating a second fan to draw heated air from the heater compartment and discharge the heated air into the second cooking zone;
sensing a temperature of the heated air discharged from the first fan at the outlet of the first fan and generating a first signal based on the sensed temperature of the heated air discharged from the first fan;
sensing a temperature of the heated air discharged from the second fan at the outlet of the second fan and generating a second signal based on the sensed temperature of the heated air discharged from the second fan;
controlling a speed of the first fan based on the first signal, including adjusting the speed of the first fan; and
controlling a speed of the second fan based on the second signal, including adjusting the speed of the second fan.
